(19) United States
(12) Patent Application Publication
(10) Pub. No.: US 2022/0405715 A1
(43) Pub. Date: Dec. 22, 2022

(54) INSPECTION RELATED SYSTEMS AND METHODS

(71) Applicant: IMRANDD LTD, Aberdeenshire (GB)

(72) Inventors: Shahram Memon, Banchory, Aberdeenshire (GB); Innes Auchterlonie, Banchory, Aberdeenshire (GB)

(21) Appl. No.: 17/638,699

(22) PCT Filed: Sep. 2, 2020
(86) PCT No.: PCT/EP2020/074481

§ 371 Date: Feb. 25, 2022

(30) Foreign Application Priority Data
Sep. 2, 2019 (GB) 1912607.7

(51) Int. Cl. G06Q 10/00

(52) U.S. Cl. CPC G06Q 10/20

(57) ABSTRACT

A method of processing inspection data and an associated system, computer program product and user interface, the method comprising: collecting two or more datasets, each dataset comprising data associated with an inspection process of an particular asset; isolating, from those data sets: (i) data that varies beyond a particular threshold based on the other data within that dataset; (ii) data that varies beyond a particular threshold based on a comparison of data between the two or more datasets; and (iii) data that is considered erroneous; and using remaining data as inspection data for that particular inspection process.

### CROSS-REFERENCE TO RELATED APPLICATIONS

This application is a national phase entry under 35 U.S.C. § 371 of International Patent Application PCT/EP2020/074481, filed Sep. 2, 201920, designating the United States of America and published in English as International Patent Publication WO2021/043832 on Mar. 11, 2021, which claims the benefit under Article 8 of the Patent Cooperation Treaty to Great Britain Patent Application Serial No. 1912607.7, filed Sep. 2, 2019, the entireties of which are hereby incorporated by reference.

### TECHNICAL FIELD

Described examples relate to systems and methods for data processing, and in particular processing of inspection data for the oil and gas industry. In some examples, the systems and methods are provided in order to evaluate inspection data associated with a particular asset, such as an oil and gas asset (e.g. platform, vessel, etc.)

### BACKGROUND

Poor confidence in the quality of inspection data collected is widely accepted as a persistent problem affecting the entire oil & gas industry, as inspector error can be minimised but not eliminated. As a result, preventable failures are often missed, data trending can remain the goal but not the reality, failure patterns and hotspots are not identified, and genuine anomalies are often overlooked.

As such, there is a need for a rapid and cost-effective methodology to restore confidence in inspection data, enabling evaluation of threat levels associated with an asset and for improving asset or degradation management.

This background serves only to set a scene to allow a skilled reader to better appreciate the following description. Therefore, none of the above discussion should necessarily be taken as an acknowledgement that the discussion is part of the state of the art or is common general knowledge. One or more aspects/embodiments of the invention may or may not address one or more of the background issues.

### SUMMARY

Various aspects of the present invention are defined in the independent claims. Some preferred features are defined in the dependent claims.

According to an aspect of the present disclosure is a method of determining or monitoring at least one condition of an asset. The method may comprise collecting two or more datasets, each dataset comprising data associated with an inspection process of the asset. The method may comprise identifying, from those data sets, data meeting one or more potentially anomalous data rules. The one or more potentially anomalous data rules may specify at least one of: (i) data, e.g. extreme data, that varies beyond a particular threshold based on the other data within that dataset; (ii) data, e.g. excepted data, that varies beyond a particular threshold based on a comparison of data between the two or more datasets; and/or (iii) data, such as error data, that is considered erroneous. The method may comprise isolating or segregating, from the two or more datasets, the data identified as meeting one or more or each of the potentially anomalous data rules, which may leave remaining data. The method may comprise using the remaining data to determine the at least one condition of the asset.

The segregated data, which may be considered “potentially anomalous data”, may be or comprise the data identified and/or isolated using (i), (ii) and/or (iii) above. The remaining data, which may be considered “good data”, may be the data in the two or more datasets other than the isolated data. The data may comprise data in the two or more datasets or parameters determined therefrom (e.g. processed data). The method may comprise flagging the “potentially anomalous data” for further action.

The method may comprise performing feature level or localised analysis. The method may comprise performing circuit level or general analysis, which may be performed subsequently to the feature level or localised analysis.

The feature level or localised analysis may comprise analysing localised data, which may comprise analysing data and/or determining parameters of or associated with a specific feature or component of, or location in or on, the asset. The method may comprise processing the localised data differently to data that is more general data and/or associated with a circuit such as a corrosion circuit. The data received in the datasets may comprise localised data, e.g. associated with discrete measurement or inspection locations.

The localised data may be associated with a high variation in data, e.g. intra- or inter- data set variation in data from the datasets for a portion of an asset or circuit may be above a variation threshold. The feature level or localised analysis may comprise determining a probability distribution for the localised data, e.g. based on an expected distribution, such as a linear distribution, or a “best fit” probability distribution. The method may comprise determining a probability distribution for the localized data or localized data groups that is different to a probability distribution provided for the general data. The method may comprise using the probability distribution of the data for a respective feature or location to determine the properties or parameters for that respective feature or location and/or the expected or nominal values for data and/or the properties or parameters for that respective feature or location.

The method may comprise determining properties or parameters of the respective features or locations from the at least one dataset. The method may comprise using the probability distribution for the respective feature or location to determine the parameters for that feature or location. The feature level or localised analysis may comprise applying the one or more of the potentially anomalous data rules (e.g. the potentially anomalous data rules that specify the extreme data) to the data in the data sets and/or the properties or parameters (e.g. processed data) for the features or locations of the asset, e.g. in order to identify “extreme data” for at least one or each feature or location.

The feature level or localised analysis may be performed on a feature by feature or on a location by location basis. The feature or location of the asset may be or comprise a test, measurement and/or inspection location of the asset. The feature may be a component of the asset such as, by way of non-limiting example, a section of a pipe, a vessel, a conduit, a tank, a container, a valve, a pump, an item of machinery or the like. The data in the data set may comprise, by way of non-limiting example, wall thickness of the feature or at the location. The parameter of the feature or location (e.g. processed data) may comprise a degradation (e.g. corrosion) rate, which may be derived from the wall thickness data, and/or a remaining lifetime, which may be derived from the determined degradation rate and the wall thickness data.

By way of example, identifying if the determined properties or parameters meet the one or more potentially anomalous data rules may comprise one or more of: determining if the current wall thickness is below a threshold, the corrosion or degradation rate (e.g. a maximum corrosion or degradation rate) is above and/or below a threshold, the remaining lifetime is below a threshold, and/or the like. However, it will be appreciated that the above are only examples of the potentially anomalous data rules that could be used.

The thresholds specified by the potentially anomalous data rules may be based on, or define a variation from, an expected value. The expected value may be based on an expected trend, e.g. a linear or other trend. The expected value may be based on at least one of: the values of data within one or more datasets or properties or parameters or a probability distribution derived therefrom, experience, modelling, historical use, manufacturer's ratings, and/or the like.

The one or more potentially anomalous data rules may specify data meeting an alarm or fail condition. The one or more potentially anomalous data rules may specify data for which a time since last measurement or inspection is greater than an age threshold.

According to (i) data identified as to be isolated may vary outwith an expected trend. For example, the anomalous data rule (i) above may specify a degradation or corrosion rate being above or below a threshold, an estimated or measured property of a component of the asset (e.g. wall thickness) being below an alarm or allowed threshold, a predicted remaining life of a component of the asset being less than a threshold (e.g. based on estimated wall thicknesses), and/or the like. The anomalous data rule (i) and/or (ii) above may specify data associated with features of, or locations on or in, the asset that have a variation in data, e.g. compared to other data for that test point or component of the asset in the same or other datasets, that is higher than a threshold, such as a variation in wall thickness measurements being greater than a threshold.

The anomalous data rule (iii) above may specify a time since the data was collected or last inspection or measurement or being greater than a threshold, or no or not enough “good data” being available, optionally with a predicted degradation or reduction in parameter, such as rate of wall thickness loss, being greater than an alarm or minimum acceptable level.

The method may comprise assigning priorities to determined properties or parameters and identifying or actioning the extreme data differently depending on priority, e.g. to vary the speed, urgency, or mode of alarm or flag depending on priority.

The method may comprise segregating the data that has been determined to meet at least one of the potentially anomalous data rules, e.g. data or parameters that are determined to be extreme data, excepted data or error data. Segregating the data that has been determined to meet at least one of the potentially anomalous data rules from the one or more datasets may leave “good data” from the one or more datasets.

The method may comprise prompting, actioning or flagging data for attention, re-inspection or re-measurement and/or further investigation, e.g. via an automatic alert, message, flag, alarm, inclusion on a list or display, or the like, e.g. responsive to the data being determined to meet at least one of the potentially anomalous data rules, e.g. data or parameters that are determined to be extreme data, excepted data or error data.

The method may comprise classifying the data determined to meet at least one of the potentially anomalous data rules. The classification may determine the action to be taken. The data that has been determined to meet at least one of the potentially anomalous data rules may be considered to be a measurement over which there is doubt or where there is doubt of the correctness of associated data such as pipe specification.

The further investigation may be a manual or desktop investigation. The further investigation may comprise determining if the data that has been determined to be extreme data comprises or is due to incorrectly assigned data or spurious data. For example, an expected value of a feature may depend on assigned data such as, for example, material, pipe class, one or more process conditions and/or the like. As such, the data being determined to meet at least one of the potentially anomalous data rules may be due to incorrectly assigned data. The spurious data may comprise data in the wrong format (e.g. being a letter when it should be a number, or being negative when only positive values are possible and/or the like).

The data flagged for further investigation (e.g. data to investigate) may comprise data that is unlikely or unrealistic. For example, a parameter for a given measurement may be provided with an acceptable range, which may be indicative of realistic or sensible values for that parameter and measurement. If the data is outwith the acceptable range, then it may be determined to be data to investigate. The method may comprise automatically flagging or otherwise identifying data to investigate for manual investigation, e.g. by displaying a flag in a user interface, including an indication of the data to investigate in an electronic report, forwarding an electronic communication to specified users, and/or the like.

The method may comprise un-segregating the data or returning or replacing data previously determined to meet at least one of the potentially anomalous data rules in the one or more data sets once the data has been investigated and determined to be correct or the data has been corrected or superseded by data from a re-inspection or re-measurement. The method may comprise further actioning any data that is still determined to meet at least one of the potentially anomalous data rules even after re-inspection or re-measurement and/or after further investigation of the data, e.g. by indicating on a display, providing the data for further analysis, raising an alarm, alert, or flag, including the data on a display, model or report, keeping the data segregated and/or the like.

The segregated data may comprise data that does not trend with the rest of the remaining data but may not be significant, e.g. if it does not result in a variation or risk in a determined parameter that is greater than a threshold amount. The data to exclude or isolate may, for example, relate to a weldolet in a pipeline where the wall thickness at the weldolet is thicker than the rest of the pipeline and with very low corrosion rates.

As such, the method may comprise determining whether the data determined to meet at least one of the potentially anomalous data rules is potentially a threat or benign. The method may comprise prompting, actioning or flagging data that is determined to be potentially a threat for re-inspection, re-measurement and/or further investigation. The method may comprise simply segregating the data that is determined to be benign, which may be without further action. In this way, for example, data that is considered to be outwith an expected range, such as a pipe wall being too thick, may be considered benign and excluded but an action may not be raised. The benign data may not present a threat worth raising an action, flag or notification for but may have the potential to skew the data. In this way, actions, prompts and flags may only be raised or may be more urgently or raised for extreme data that is considered to be a threat, which may allow these to be more readily identifiable but data that may potentially skew the remaining data may be removed regardless.

The method may comprise performing circuit level analysis, which may comprise analysing data and/or determining properties associated with a circuit, such as a corrosion circuit, that is comprised in the asset. The corrosion circuit may comprise portions or a plurality of features of the asset that share at least one common behaviour or rate or mechanism, e.g. that are expected to degrade or corrode at the same or similar (e.g. within a threshold amount) rates. The corrosion circuit may comprise a plurality of features or locations in or on the asset, which may be subject to similar expected corrosion rates, comprise the same or similar components, be formed from the same or similar material, be subject to the same or similar process conditions, be subject to the same or similar process conditions and/or the like. The circuit level analysis may be performed subsequently to the feature level analysis, and may be performed on (e.g. only on) “good data” output from the feature level analysis.

The analysis may comprise, for each circuit, determining and/or classifying a damage mechanism, e.g. a damage mechanism that is dominant or prevalent, for that circuit. The damage mechanism may be determined or classified from the “good data”, which may be the “good data” output from the feature level analysis

The circuit level analysis may comprise, for each circuit, further applying the potentially anomalous data rules, such as determining if any of the data varies beyond a particular threshold based on a comparison of data between the two or more datasets, e.g. to determine excepted data. The two or more data sets in potentially anomalous data rule (ii) may comprise two more data sets representing features within a respective corrosion circuit. The circuit level analysis may comprise, for each circuit, further segregating, from the two or more datasets, the data identified as meeting one or more of the potentially anomalous data rules, e.g. data that is classified as excepted data. The circuit level analysis may comprise determining, for respective circuits or each circuit, data for which further investigation is required. The data for which further investigation is required may comprise data for which there is a high ratio of measurements outwith an expected or nominal range, e.g. a high ratio of wall thickness values above a nominal or expected wall thickness. The data for which further investigation is required may comprise data that has a high ratio (e.g. above a predetermined threshold) of measurements outwith the expected or nominal range. The circuit level analysis may comprise flagging or sending the data for which further investigation is required for further action, e.g. for manual or desktop investigation or checking of the data. The circuit level analysis may comprise, for each circuit, determining if there is enough good data to perform a statistically meaningful analysis. The circuit level analysis may comprise flagging any data for which there is insufficient good data, that will require further action such as re-inspection.

The circuit level analysis may comprise categorizing the determined corrosion in the corrosion circuit as “general corrosion” and “localised corrosion”, e.g. by using statistical analysis, fitting functions or distributions to the data, and/or the like. The localised corrosion may be associated with locations or components in the corrosion circuit that give rise to the “extreme” data or at least data or properties or paramters determined therefrom that is outwith a threshold amount from a predetermined expected value or trend, which may be designated as “hotspots”. The general corrosion may be based on “good” data or data or properties or parameters determined therefrom that are within the threshold amount of the expected value or trend and may represent an underlying, long term or overall corrosion rate.

The corrosion level analysis may comprise flagging data or the properties or parameters determined therefrom as “general corrosion” or “localised corrosion” for display and/or provision of advanced insights.

The method may comprise dividing the circuit or asset based on the rate of degradation (e.g. corrosion) determined for each portion or component of the circuit or asset and/or based on the extreme data identified in (i) above and/or the excepted data identified in (ii) above.

The division of the circuit may be based on one or more sampling rules. The sampling rules may specify divisions in the circuit or asset based on largest degradation (e.g. corrosion) rate, which may be a largest degradation rate derived from the extreme values identified in (i) above. For example, the sampling rules may specify dividing the circuit or asset into portions for which the degradation rate is the same or similar (e.g. within a threshold). The division of the circuit or asset may comprise dividing the circuit or asset into hotspots having a higher or highest rate of degradation, e.g. being associated with or whose degradation rate is based on the extreme values identified in (i) above, and general degradation having an average or lower rate of degradation, e.g. being associated with or whose degradation rate is based on the remaining or good data. The method may comprise providing the divisions and/or an indication of the associated degradation rate and/or an indication of whether or not the degradation is a hotspot or has general degradation on a schematic of the circuit or asset, e.g. on a P&ID or other circuit diagram or on an isometric representation or other model view of the circuit or asset, and/or in a table or heat map indicating the determined degradation rates, e.g. localised and general degradation rates and/or areas for further investigation, and/or in a summary or digest of hotspots, and/or the like.

The remaining data (e.g. the “good data”) may be or comprise data that meets one of the following: has sufficient data, e.g. more than a threshold, for a given test point or component of the asset; has a low variation, e.g. within a threshold, in the individual and/or combined dataset for a given test point or component of the asset, does not contain extreme values, e.g. beyond a threshold value, and/or the like.

The segregated data (e.g. the “potentially anomalous data”) may be or comprise data that meets at least one of the following: data that contains extreme values (which may be subsequently identified as being accurate or inaccurate), data that contains errors or at least has a high probability of being erroneous, and/or the like.

The general data may comprise data that follows a trend, such as an expected trend (e.g. within a threshold amount of the trend) and/or have a variation less than a threshold.

The method may comprise pre-processing, which may be carried out before the identifying of the data meeting one or more potentially anomalous data rules, e.g. before the feature level or localised analysis and/or before the circuit level or generalized analysis.

The pre-processing may comprise identifying and filling in gaps in the data, e.g. by interrogating different databases, providing a data request (e.g. by electronic message, displaying the request on a screen, including the request in an electronic report, etc.), extrapolating data, and/or the like. The pre-processing may comprise re-formatting at least one of the datasets into a new format. The pre-processing may comprise converting data from a format associated with one software package to another. The pre-processing may comprise applying a map to map data from at least one of the datasets, e.g. in one format, into a standardized dataset in another format.

As noted above, the method may comprise raising an action in relation to the data, e.g. when the data is determined to be potentially anomalous data, such as extreme data, data due to a measurement over which there is doubt, incorrectly assigned data, data that indicates a potential threat, data for which there is a high ratio of measurements outwith a nominal or expected range, data for which there is insufficient good data, and/or the like.

The raising of the action may comprise checking the data for which the action has been raised against a list of known anomalies and, if the data is associated with a known anomaly, may comprise providing an indication that the data is due to the known anomaly and/or not requiring any further action. The checking of the data for which the action has been raised against a list of known anomalies may be responsive to it being determined that the data is data meeting one or more potentially anomalous data rules, e.g. extreme data, or if it is determined that there is not enough good data, e.g. for a circuit.

The raising of the action may comprise flagging the data for re-inspection or re-measurement, e.g. if it is determined that there is not enough good data for a circuit. The re-inspection or re-measurement may be manual, automated or automatic.

The raising of the action may comprise flagging the data for investigation, e.g. manual or desktop investigation, which may be responsive to it being determined that the data is extreme data, or if there is a high ratio of measurements above a nominal or expected value.

The raising of the action may comprise raising an alarm, alert or other notification, which may comprise providing an indication on a visualization or circuit diagram of the asset or circuit, an electronic message, an indication on a display, an indication in an electronic report, and/or the like.

As noted above, the method may comprise determining one or more degradation rates, e.g. based on the circuit level or general analysis (e.g. based on the general data) and/or the feature level or localized analysis (e.g. based on the feature or localized data and/or on each localized data group). For example, the method may comprise determining an overall degradation rate from the general data and one or more localized degradation rates from the localized data or localized data groups. The degradation rate may comprise determining an average degradation or corrosion rate and/or a maximum degradation or corrosion rate, such as a long term and/or short term degradation or corrosion rate. Any action, alarm or alert may be performed based on the maximum determined degradation or corrosion rate.

The method may comprise providing a data visualisation or advanced insights, e.g. by providing a heat map, presenting the data and/or any alarms, alerts or notifications on a plot, providing tables indicating the determined degradation rates, e.g. feature level or localised and/or circuit level or general degradation rates and/or areas for further investigation, a summary, representing the data and/or any alarms, alerts or notifications and/or the like on a circuit or asset diagram, e.g. a piping and instrumentation diagram (P&ID), isometric or other model, and/or the like. The extreme data, good data, all data or any combination thereof may be provided on different visualizations or toggled between the data types on a single visualization. For example, any data that is determined to data meet one or more potentially anomalous data rules, e.g. extreme data, may be associated with a corresponding location or feature in the asset and identified at a corresponding location on the P&ID, isometric, model and/or the like.

The method may comprise obtaining identifiers, one or more properties or type classifications for each asset or circuit or component or portion thereof, e.g. from a data store. The method may comprise obtaining a P&ID diagram, isometric or other model diagram of at least part of the asset or circuit, and/or the like from the data store. The method may comprise providing indications of the data that meeting at least one of the potentially anomalous data rules, e.g. the extreme data, on the P&ID diagram, isometric or other model of the asset dependent on the location on the asset that the data relates. The visualization may comprise displaying the identifiers, one or more properties or type classifications for each asset or circuit or component or portion thereof along with a degradation rate thereof

The method may comprise re-performing the method or iteratively updating the method, e.g. periodically or when new data has been identified or supplied or when portions of the circuit or asset are identified as having high degradation or risk of failure. At least one of the iterations may comprise including or reintegrating data previously segregated, for example extreme data, e.g. because it has been checked or re-inspected and it is shown that the extreme data was incorrect and has been corrected or shown to be good data. Each iteration may improve the good data and/or trendable data set; and/or give a better understanding of degradation mechanisms and/or give a data set that excludes more errors and/or less extreme values.

The method may comprise raising an alarm or alert, e.g. if a maximum degradation rate and/or a remaining lifetime for components of the circuit or the asset is above or below a threshold, and/or based on one or more statistical alarm trigger conditions. The method may comprise determining the remaining lifetime for components of the circuit or asset based on the degradation rate and optionally other data such as installation lifetime, rated lifetime, original wall thickness, one or more original or new properties of the asset or component in the circuit, degradation models for the asset, circuit and/or components or portions thereof, and/or the like. The degradation models may be pre-provided and/or based on test data, historical data, modelling, manufacturer's specifications, theoretical calculations and/or the like. The alarm may be a real time alarm. The alarm may comprise a visual alarm, an electronic message, an indication on a representation of the asset or circuit such as on the isometric diagram, model view and/or on the P&ID or other circuit diagram. The alarm or alert may provide the degradation rate and/or the remaining lifetime for at least one component of the circuit or the asset.

According to a second aspect of the present disclosure is a processing system configured to implement the method of the first aspect.

The processing system may comprise one or more processing modules, which may comprise one or more central processing units (CPUs), one or more graphical processing units (GPUs), one or more maths co-processors, one or more field programmable gate arrays (FPGAs), one or more application specific integrated circuits (ASICS), and/or the like, which may be configure or programmed to perform the method of the first aspect.

The processing system may comprise and/or be configured to access one or more data stores, e.g. for storing the datasets, inspection reports, thresholds, circuit or asset information, such as P&ID or other circuit diagrams, isometric or other model representations of the circuit or asset, and/or the like.

The processing system may comprise one or more user input devices, for receiving user input. The processing system may comprise or be configured to access one or more display or other output devices, which may be configured to provide the alarm, alert, data visualization, representation, and/or the like.

In some examples, there is described a computer program product that when programmed into a suitable controller configures the controller to perform any methods disclosed herein. There may be provided a carrier medium, such as a physical or tangible and/or non-transient carrier medium, comprising the computer program product. The carrier medium may be a computer readable carrier medium.

According to an aspect of the present disclosure is a graphical user interface (GUI) implemented on a computer based system, the GUI being configured to display average, maximum and/or minimum degradation rates such as corrosion rates, and/or remaining lifetime for an asset or circuit or one or more features, components and/or portions thereof, wherein the average, maximum and/or minimum degradation rates such as corrosion rates, and/or remaining lifetime is/are determined using the method of the first aspect. The average, maximum and/or minimum degradation rates such as corrosion rates, and/or remaining lifetime may be indicated on a visualization, which may comprise a circuit diagram such as a P&ID and/or on a model representation such as an isometric model representation and/or on a heat map.

The invention includes one or more corresponding aspects, embodiments or features in isolation or in various combinations whether or not specifically stated (including claimed) in that combination or in isolation. As will be appreciated, features associated with particular recited embodiments relating to systems may be equally appropriate as features of embodiments relating specifically to methods of operation or use, and vice versa.

The above summary is intended to be merely exemplary and non-limiting.

### BRIEF DESCRIPTION OF THE FIGURES

A description is now given, by way of example only, with reference to the accompanying drawings, in which:

FIG. 1 a flowchart of an asset monitoring process;

FIG. 2 a block diagram of a system for performing the process of FIG. 1;

FIG. 3 an example of a dataset that requires further investigation;

FIG. 4 an example of a localized dataset;

FIG. 5 an example of a general dataset;

FIG. 6 an example of a data visualization;

FIG. 7 another example of a data visualization;

FIG. 8 an example of a coverage calculation; and

FIG. 9 a flowchart of an asset monitoring process.

### DESCRIPTION OF SPECIFIC EMBODIMENTS

Various specific examples are shown the drawings and described below. These are intended to give examples of possible implementations of the present disclosure but are not intended to be limiting.

Methodology described herein uses models and algorithms that: identify bad data; does not filter genuine anomalies; improves incomplete data sets by introducing gathered data into standard models for greater accuracy; and/or determines threat level associated with each system. As a result, methodology described herein can: predict failures; provide accurate corrosion rates & remaining life; improve the understanding of asset risks; better target inspection and allocate resource; and/or optimise inspection coverage.

Inspection and monitoring of assets and early identification and actioning of conditions or machine states that could lead to failures are key to efficient operation of such assets. However, poor confidence in inspection and asset parameter measurement data is an ongoing problem and may lead to unfavourable circumstances such as, for example, unnecessary interventions, early interventions when there is still significant usable life, or failure to identify imminent failures until it is too late. An example of an asset might be a flow system comprising one or more types of pipework, pumps, valves, meters, tanks, and/or the like. Such flow systems are commonly used in the oil and gas industry, both upstream and downstream.

Examples described herein seek to restore confidence in inspection data, which may include historical inspection data, by classifying and separating out erroneous data, low confidence data and high confidence data. The described systems can provide an appropriate alarm or action and/or provide advanced insights into the state of an asset with a high degree of confidence.

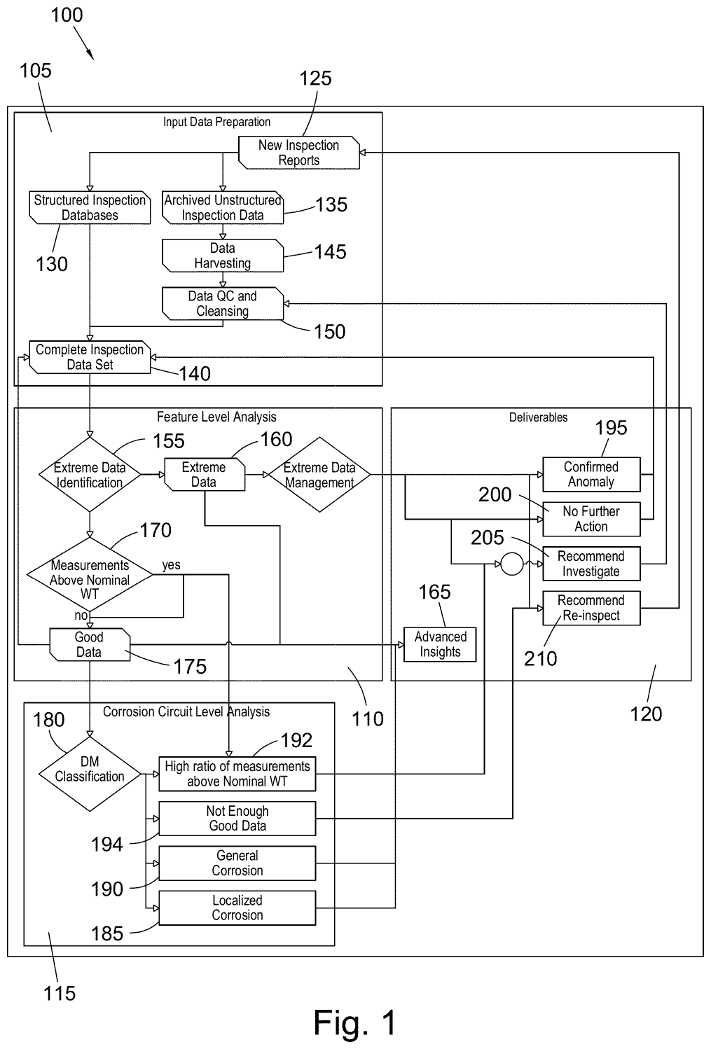

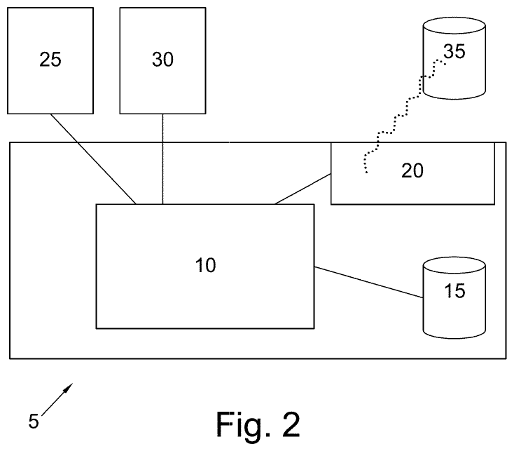

An asset monitoring process flow 100 is illustrated in FIG. 1. The process flow can be implemented on a suitable processing and/or monitoring system, such as but not limited to the system 5 shown in FIG. 2. The process flow is divided into four sections, namely input data preparation 105, feature level analysis 110, circuit level analysis 115 and delivery 120.

The input data preparation 105 deals with data received by the system 5. This may be in the form of new inspection reports 125 (also referred to as new data) and also data that has previously been processed by the system 5 but segregated, e.g. due to it being identified as extreme data, due to it having a high ratio of measurements that are outwith a nominal or expected range or there simply being not enough good data to perform a reliable or statistically significant analysis, amongst other potential reasons, and subsequently re-inspected or re-measured, or checked to confirm that the data is correct.

The new inspection reports 125 are intended to represent inspection reports that are new to the system 5 but need not be recent inspection reports and could include historical inspection reports. The inspection reports 125 can contain digital measurement data collected using measurement instruments or apparatus and/or manual inspection data that has been input into a digital format. The system 5 requires the inspection reports to be in a particular format and the new inspection reports 125 may or may not be in that format. In particular, historical inspection reports are less likely to be in the required format. The system 5 determines if the new inspection reports are structured inspection reports 130 (i.e. asset inspection reports in a format that can be processed by the system 5) or unstructured inspection reports 135 (i.e. asset inspection reports that are not in a format that can be processed by the system 5). For example, the unstructured inspection reports 135 could be historical or archived inspection reports.

If the new inspection reports 125 are structured inspection reports 130, then they can be directly incorporated into a complete inspection data set 140.

If the new inspection reports 125 are unstructured 135, then the data needs to be harvested 145 from the unstructured inspection data sets 135. This can be done, for example, by mapping the unstructured asset inspection data sets 135 to the structured inspection data set 130 format (e.g. by utilising a set of mapping rules that map data fields in the unstructured report 135 format to data fields in the structured report 130 format), but it will be appreciated that there are other techniques for performing such conversions.

The data output from the harvesting 145 is subject to data quality control and cleansing operations 150. This may involve methods such as de-duping data, removing clearly anomalous data (e.g. text data in a number field or vice versa or negative values where only positive values are possible), rejecting data sets that have essential data or values missing, and/or the like. As will be described below, in examples, the data quality control and cleansing operations 150 may also be applied to data that has previously been processed by the system 5 and subjected to an investigation (e.g. a manual or desktop inspection) and determined to be correct or that has been corrected, with a view to re-incorporating that data back into the complete data set 140.

Once the now structured data derived from the unstructured asset inspection data 135 (and/or the correct or corrected data returned for re-incorporation from the re-inspection or investigation) has been subjected to the data quality control and cleansing process 150, the data is incorporated into the complete inspection data set 140.

The data from the complete inspection data set 140 can be processed using the feature level analysis 110. The feature level analysis 110 may collect data together for respective features (e.g. measurement points, locations, components, etc.) of the asset. For example, a feature may be a particular section of pipe, a particular pump, a particular valve, a particular tank, or a particular measurement point where a measurement is taken and/or the like. However, the features of the asset are not limited to these and it will be appreciated that other features may be analysed, depending on the particular asset.

Optionally, the feature level analysis 110 may comprise determining parameters of the feature from the data in the complete inspection data set 140 that relates to that feature. For example, the data in the complete inspection data set 140 may comprise a plurality of wall thickness values taken over a period of time for a feature such as a section of pipe or a tank. The system 5 may determine a parameter of the feature from the data for the feature, e.g. a degradation or corrosion rate can be determined from the change / reduction in wall thickness values over time for that feature. In other examples, the parameters could comprise long and/or short term corrosion rates by determining the reduction in wall thickness values for that feature over long and/or short immediately preceding timeframes respectively. In another example, the parameter may be a current wall thickness for a feature determined by extrapolating from a series of historic values of wall thickness. However, it will be appreciated that the parameters that could be determined are not limited to the above and that other parameters, features and/or data could be used depending on the application, asset and the requirements of the operator.

The feature level analysis 110 comprises processing the asset inspection data from the complete inspection data set to identify if any of the data can be classified as “extreme data” 155. In particular, an extreme data rule set can be applied to the asset inspection data from the complete inspection data set for a given feature and/or one or more of the determined parameters derived therefrom. In general, the extreme data rule set may define a threshold for the data or parameters; or an allowable threshold variation from an nominal or expected value of the data or parameter; or a threshold allowable variation between data or parameters derived from different data sets for the given feature. The data (or the parameter determined therefrom) may be classified as “extreme data” if the values of the data or parameter lie outwith the threshold or threshold variation from the expected or nominal value or trend.

For example, the parameter could be degradation or corrosion rate and the extreme data rule set may specify that the parameter or data is extreme data if the corrosion rate is over a threshold amount above an expected or nominal corrosion rate for the given feature. In another example, the data may comprise wall thickness for a given feature and the extreme data rule set may specify that the parameter or data is extreme data if the wall thickness is below a threshold amount below an expected or nominal wall thickness for the given feature. In another example, the parameter for a given feature may be remaining lifetime based on an extrapolation from the current wall thickness to an alarm level for wall thickness based on the determined current corrosion or degradation rate, and the extreme data rule set may specify that the parameter or data is extreme data if the determined remaining lifetime for the given feature is below a threshold amount. It will be appreciated that the above are merely examples of possible extreme data rules and that other or alternative extreme data rules based on the same or different data or parameters could be used.

One or more of the extreme data rules may specify data that varies beyond a particular threshold based on the other data within that dataset. For example, data for a particular feature may be classified as extreme data if the values of the data or the parameters derived therefrom within a particular data set vary beyond a threshold degree or a statistical measure that may optionally include a coefficient of variation or coefficient of determination or the like, that is the data within the data set exhibits a high degree of variation.

One or more of the extreme data rules may specify data that varies beyond a particular threshold based on a comparison of data between the two or more datasets. For example, if a plurality of different inspection reports are available for a given feature (and optionally for the same time period) and the data values and/or values or one or more parameters determined from the data in the data sets for that feature vary from each other by more than a threshold amount, then the data sets may be classified as extreme data. Similarly, if a plurality of datasets spanning a period are available and usable to determine an expected value or trend for a value, the data from a later collected data set can be identified as extreme data if it varies from the expected value or trend derived from the earlier collected datasets.

If data in the complete inspection data set is identified as being extreme data 160 then the extreme data is flagged as such and forwarded to an advanced insights module 165 to be provided (e.g. presented, displayed or otherwise conveyed) to a user for asset condition monitoring, i.e. monitoring of a machine state of the asset, which is discussed in more detail with respect to the delivery stage 120. In addition, the extreme data 160 can also be flagged for further action, such as re-inspection, re-measurement or manual investigation, which is also discussed in more detail with respect to the delivery stage 120. The extreme data 160 in this case may be considered as data that is potentially anomalous and requires potential action.

If data in the complete inspection data set 140 is not classified as extreme data, i.e. it does not meet any of the requirements set out in the extreme data rule set that specifies the extreme data 160, then it is passed to a further check to determine if the data is potentially anomalous but benign 170.

For example, the check to determine if the data is potentially anomalous but benign 170 may comprise determining if a wall thickness is above a nominal or expected value. This condition is likely safe and no damage is likely to result but the data could potentially be anomalous and could at least skew any analysis if included in the good data set. In this case the data could be segregated from the rest of the data (e.g. from the good data) but no further action need be required, or at least the further action could be limited to a manual inspection of the data, e.g. to identify a cause of the potentially anomalous but benign finding, e.g. due to a baseline error, or that the feature comprises a weldolet that may be thicker than the surrounding pipe but is not a reason for concern, and/or the like.

Any data that is neither identified as extreme nor benign but potentially anomalous is considered to be “good data” 175.

The good data 175 is then further analysed using the circuit level analysis 115. That is, the good data 175 comprises data for a plurality of features or locations identified in the feature level analysis (i.e. which performs its analyses on a feature by feature basis). However, one or more, e.g. a plurality, of the features having at least one behaviour or property in common may be grouped in to circuits, such as corrosion circuits. In the example of corrosion circuits, each of the plurality of features in each respective corrosion circuit is expected to corrode or degrade at the same or a similar rate. For example, respective corrosion circuits may comprise pipes that are formed from the same material, with the same wall thickness and experience the same fluid and similar process conditions. The concept of corrosion circuits per se are known and any of a range of types of corrosion circuits and methods for determining them could be used.

For each respective circuit, e.g. corrosion circuit, a damage mechanism is determined 180. There may be a range of mechanisms for determining the damage mechanisms such as determining the best fit of the data or parameters derived therefrom or changes therein against a template or profile from amongst a range of templates of profiles indicative of a range of damage mechanisms. However, the present process is not limited to any particular technique for determining the damage mechanism 180 and other suitable techniques may be used.

At this point, any remaining “good” data 175 should have minimum variation. However, this is not always necessarily the case, as any degradation mechanism may be localised but still have low to medium degradation rates, such as in flow induced erosion on a bend with low flow rates. Since such portions of the circuit degrade (e.g. corrode) at a different rate, often a higher rate, than the rest of the circuit or asset, then it is important that such data is identified, analysed and treated differently.

As such, the circuit level analysis 115 may further comprise determining if the degradation or damage (e.g. corrosion) is localised 185 (e.g. specific to a particular feature or location or circuit) or general 190 (e.g. occurring over a plurality or majority of features, locations or circuits).

For the “localised” dataset relating to localised degradation in step 185, statistical techniques are used to find a best fit probability distribution curve. Curve fitting techniques in general are well known and any suitable fitting and evaluation technique could be applied. The best fit probability distribution curve can then be applied in order to determine the worst case (but realistic) degradation rate. Since localised data may behave differently to that for the wider circuit or asset, the determined distribution for the localized data or for each localized data group may follow a different distribution curve. As such, determining degradation (e.g. corrosion) rates for the features, components or portions of the circuit or asset represented by data that has been determined to be “localised data” can be more reliably used to determining remaining lifespan. This remaining lifespan can then be output to a user device using the advanced insights 165.

Average and maximum degradation rates can be determined for every feature, component or portion of each circuit or asset. In addition, for the “localised data”, statistical degradation tables can also be calculated and output to a user device using the advanced insights 165. In this way, the system logic and/or an engineer can easily identify the most likely corrosion rate based on various factors such as considering variations in data type, the type of statistical distribution and the difference between the maximum and average or statistical degradation rates.

For the “general” data that is identified in step 190 as relating to general degradation, an average degradation rate is used, due to the low variation in data. Such data that has a low variation and is trendable is then subject to further analysis. In particular the remaining data (e.g. “good data”) 175 is used to establish a baseline degradation (e.g. corrosion) rate for the asset or circuit and/or for each feature, component or portion of the circuit or asset. Based on the baseline degradation rates, the remaining lifetime of each feature, component or portion of the circuit or asset can be determined and output to a user device using the advanced insights 165. These determined remaining lifetimes can then be used to determine inspection frequencies (e.g. at the circuit level).

In addition, the circuit level analysis 115 may further comprise determining 192 if there is potentially anomalous data that is benign, e.g. by determining if a high ratio of measurements, data or parameters are above a nominal or expected value or range for a given circuit. As an example, this may comprise determining if an above threshold ratio of wall thickness measurements are above a nominal or expected value, which may be potentially anomalous but generally benign. As another example, this may comprise determining if any of the remaining or “good data” is data with a high variation (e.g. with a variation above a threshold) and little value. If not excluded or isolated, then this data could introduce unnecessary variation in the data. One example situation is where wall thickness is taken of a pipeline system and the wall thickness taken of a weldolet might be thicker than the rest of the pipe that the weldolet is installed on, with wall thickness measurement being above the nominal wall thickness of the pipe and having very low corrosion rates. If this data corresponding to the weldolets is used, it would be of little value (as the integrity threat is low) and would cause unnecessary variation in the data trends.

The circuit level analysis 115 may also comprise determining if there is insufficient good data, e.g. to make the determination of damage mechanism for a given circuit or to appropriately characterise it.

The outputs and determinations made in the circuit level analysis 115 and/or the feature level analysis 110 may at least partially determine the action or insight provided during the delivery 120, as discussed below.

The delivery stage 120 comprises a provision of advanced insights 165, e.g. generally the presentation of an asset state, condition or report, e.g. on a user interface, wherein the advanced insights 165 may be based on the determinations made in the feature level analysis 110 and/or the circuit level analysis 115. The delivery stage 120 also comprises performing or requesting one or more actions 195, 200, 205, 210 to be taken responsive to the determinations made in the feature level analysis 110 and/or the circuit level analysis 115.

For example, one action that could be taken, which may be responsive to a determination 155 that data is extreme data 160 or that there is not enough good data is to check 195 if the data is for a feature or circuit for which there is a known, confirmed anomaly. This may involve cross referencing against a database of known anomalies. If the data is identified as relating to a known, confirmed anomaly 195, then the data may be retained but segregated from the rest of the complete inspection data set until the known anomaly is remedied, after which the segregation may be removed.

Another possibility is that no action is taken 200. For example, if it is determined that the data or parameters of a feature or circuit are potentially anomalous but benign, e.g. that measurement or a ratio of measurements, such as wall thickness measurements, are above a threshold, then no further action may be taken other than leaving the potentially anomalous but benign data segregated from the rest of the complete inspection data sets 140.

Another possible action is that the data is electronically flagged or sent for investigation 205, e.g. manual investigation by a user, which may be a desktop investigation. This may be the case if the data is determined 155 to be extreme data 160 or if it is determined that there is a high (above threshold) ratio of measurements above a nominal or expected wall thickness in the circuit level analysis. The investigation may be to, for example, check for administrative, data input or data assignment errors, e.g. the input of a wrong material for a type of pipe and the like. If the investigation confirms the data is correct or if an error is identified and corrected as part of the investigation, then the corrected data can be returned unsegregated to the input data preparation stage 105, e.g. for the data quality control and cleansing 150.

Another possible action is to electronically flag or automatically command a re-inspection 210 or re-measurement or other re-collection of data, e.g. if it is determined that the data is extreme data 160 or if there is insufficient good data.

A non-limiting example of a system 5 that may be used in the performance of the process shown in FIG. 1 is shown in FIG. 2. The system 5 comprises a processing system 10, a data store 15, a communications system 20, one or more output devices 25 and one or more user input devices 30. The communications system 20 comprises wired and/or wireless communications capability and is configured to communicate with one or more remote data stores 35. The processing system 10 comprises one or more processing units (e.g. CPUs, GPUs, maths co-processors, FPGAs, and/or ASICS) that are configured to retrieve data directly from the local datastores 15 and/or from the one or more remote datastores 35 via the communications system 20 and/or from one or more remote sensors or data sources via the communications system 20 in order to retrieve data, such as inspection reports, and any other data or information required, such as information on the circuit or components thereof, such as pipe and other component material specifications, operational data, data and reports from current risk based inspections (RBIs), circuit details (e.g. P&ID or other circuit diagrams), lists of known anomalies, models and isometric representations of the circuit, corrosion models or other behaviour for the circuit or components thereof, and/or the like. The datastores 15, 35 may comprise one or more hard disk drives, magnetic disks or other forms of magnetic storage, solid state memory devices such as flash drives, SSD drives, network attached storage (NAS), i-RAM, a RAM drive, optical disks or one or more other forms of optical storage, and/or the like. The processing system 10 is also configured to receive manual user input (e.g. user selections and/or data) from the one or more user input devices 30. The processing system 10 is configured to provide control commands and data to the one or more output devices 25, which may be local output devices physically or wirelessly connected to the processing system 10 and/or remote output devices that are connected to the processing system via the communications system 20.

The system 5 is configured to rapidly asses, cleanse, correct and present asset inspection data in a consistent and auditable manner, thereby enabling and providing evaluation of a threat level of failure or some other reportable action or alarm with respect to a machine state of the asset. This may improve both inspection and anomaly management by analysing, cleansing and improving the accuracy of inspection data already gathered. This may also provide improved monitoring of a state or condition of the asset.

As noted above, the inspection data may be inspection data relating to the asset, e.g. a fluid circuit comprising various components such as valves, pumps, and the like, connected by pipework. One specific example of an asset is a sub-surface, sub-sea and/or surface based fluid circuit such as those used in oil and/or gas extraction and/or processing, but the present invention is not limited to this. The inspection reports may comprise one or more datasets collected by sensors or measurement tools configured to measure one or more properties or parameters of at least part of the asset or circuit, such as wall thickness sensors, temperature sensors, impedance sensors, magnetic field sensors, electric field sensors, electromagnetic sensors, acoustic sensors, time-of-flight sensors, flow meters, pressure sensors, speed sensors, and/or the like. The sensor or measurement tool data can be provided to the processing system 10 via the communications system 20 using any of the communications channels described above, which may be in real time or near real time, and/or may be stored in and provided by the local or remote datastores 15, 35. The inspection reports may comprise one or more dataset that comprise manually assessed and/or input data such as data collected and/or input by an inspection engineer. One or more of the datasets may comprise operational data from the operation of the asset or circuit, e.g. collected from an asset or circuit controller. The datasets may include current, recent and/or historical data and may be received in a variety of different formats.

So for example, the datasets accessed and used by the system 5 may comprise, for example, on or more of: recent and/or historic inspection reports, material classes and/or specifications for one or more components of the system or asset such as pipe classes, specifications, degradation models or rates, operational data for the asset or circuit, e.g. temperature, pressure, operating limits, e.g. maximum and/or minimum limits, such as maximum allowed wall thickness (MAWT), any alarm details, current risk based inspections (RBIs), details of the asset or circuit such as the P&ID or other circuit diagram, listing and details of any components of the circuit or asset, a list of known anomalies, isometric or other models of the asset or circuit, process flow diagrams (PFDs), and/or the like.

Examples of the types of data that may be provided as part of the advanced insights 165 are described below. However, it will be appreciated that the advanced insights 165 are not limited to this and other data, visualizations or alarms could be provided.

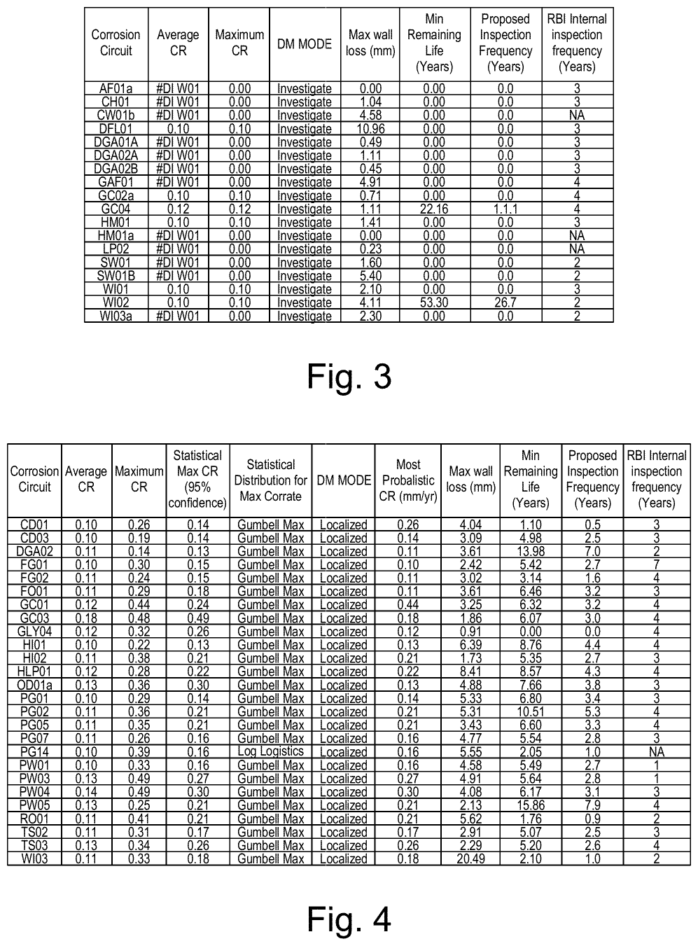

An example of data for investigation (e.g. for which investigation is recommended in step 205 of FIG. 1) that may be presented on a user interface as part of the advanced insights 165 is shown in FIG. 3. For example, an alert, user interface object or electronic message could be provided to an engineer's user device to flag data for investigation to prompt the engineer to review the “investigate” data and update the category for that data accordingly. For example, the investigation may comprise a review of the pipe material class, P&IDs or other circuit diagrams, reviewing inspection reports, existing and closed anomalies, repair work orders, and/or the like.

An example of data that is “localised” data, as determined in step 185 of FIG. 1 and that can be displayed on an engineer's user device as part of the advanced insights 165 is shown in FIG. 4. High variations in data for a particular feature, component or portion of a circuit or asset may be indicative of localised degradation. Any good data 175 having high variation for such a particular feature, component or portion of a circuit or asset is thus classified as “localised” for that particular feature, component or portion.

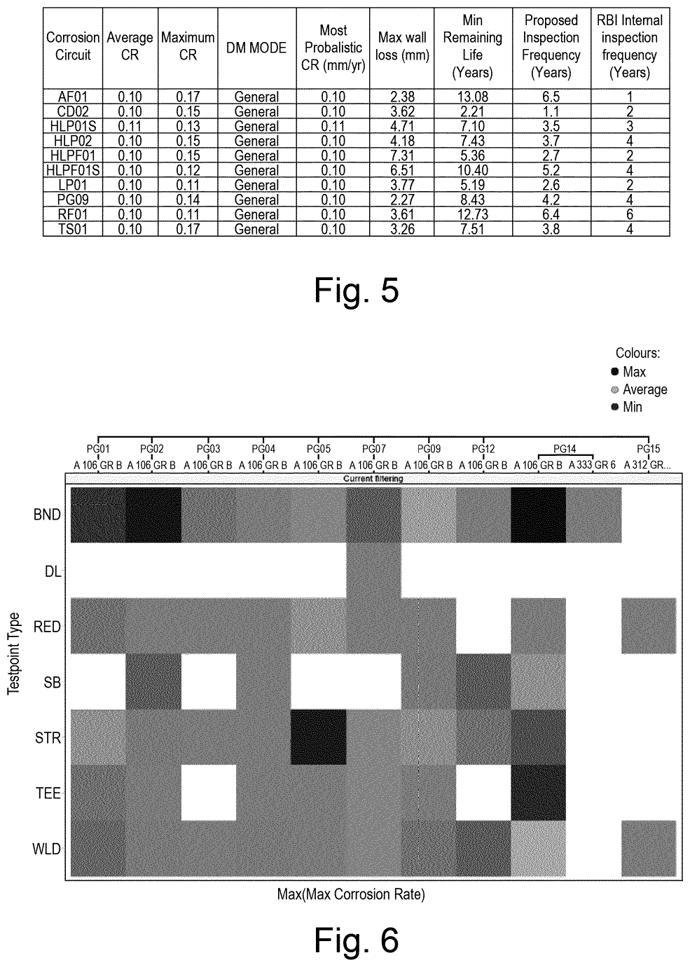

An example of data that is “general” data, as determined in step 190 of FIG. 1 and that can be displayed on an engineer's user device as part of the advanced insights 165 is shown in FIG. 5. General data is remaining or “good data” that is trendable with low variation and is indicative of generalized, usually linear degradation (e.g. corrosion) mechanisms.

The advanced insights 165 can further comprise presenting, e.g. on a user interface, visualization tools, such as heat maps, to easily identify areas with high degradation (see e.g. FIG. 6 and the associated description below). The visualization tools can be used to generate system summaries, which can in turn be included in a final output report.

As shown in FIG. 6, once the good data 175 has been separated, classified 180 and analysed, it can be visualized using suitable visualization tools. Heat maps, such as that shown in FIG. 6 can be particularly beneficial in this respect. FIG. 6 gives an example of degradation rates in the form of corrosion rates based on non-destructive testing (NDT) data sets, with the features, components or portions of the circuit or asset being listed along the horizontal top/x-axis, and the testpoint types being listed on the vertical/y-axis, and colour being used to indicate the associated corrosion rate. The heat maps show the distribution of corrosion rates, from maximum to minimum for a given circuit or asset, its material grade and type by feature. The example shown relates to a produced gas system, and it can be seen that the highest corrosion rates are concentrated in the bends of portions PG02 and PG14 and in the straight sections of portion PG05 of the circuit, and that the pipework in these portions is carbon steel A106 Grade B. The uncoloured areas show an absence of data, e.g. because it hasn't been collected (which may need to be addressed, e.g. by re-inspection or re-measurement 210) or because the feature type in the vertical axis does not exist in that portion of the circuit or asset. Uncoloured areas may also indicate a lack of “good data” (determination 194 in FIG. 1).

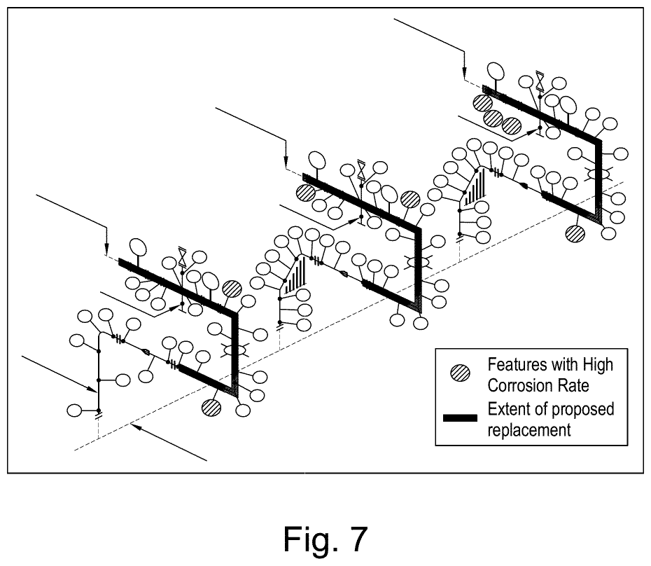

The data identified 155 as “extreme data” 160 is also subject to analysis. In this case, any “hotspot” features, components or portions of the circuit or asset that give rise to “extreme” values can be beneficially identified and, for example, indicated in an isometric model of the circuit or asset, along with an indication of the associated degradation rate and/or remaining lifetime, as explained below in further detail with reference to FIG. 7.

If the engineer or logic of the system 5 determines that the “extreme data” values associated with a given hotspot do not pose any threat and it is most likely caused by an error (e.g. as part of the investigation 205), then that data is simply segregated. That is, remaining “extreme” data 160 can be investigated 205, e.g. by checking if the “extreme” data values are the result of an obvious error, such as a typo, incorrect reference data and the like. This may be carried out as a desktop exercise using a suitable user interface.

If more information is required to establish whether the property represented by the data, such as wall thickness, is valid, then the re-inspection 210 can be flagged to collect updated data. The process can then be re-run with the updated data collected from the re-inspection 210 included in the new data preparation stage and it can be determined if the data is still identified as “extreme” and potentially gives rise to immediate integrity issues. If so, then remedial action can be recommended. If not, then consideration can be given to creating a sub-circuit portion or different inspection frequency for that feature, component or portion of the circuit or asset that gave rise to the “extreme” value to take into account the degradation rate and/or remaining lifetime associated with the “extreme” data and/or the associated feature, component or portion of the circuit or asset. Any remedial actions, sub-circuit portion and/or changes to inspection frequency proposed can then be included in an output report.

As part of the analysis and visualization process, the system 5 is configured to divide up the asset into divisions based on the estimates of the remaining lifetime and/or degradation rate for the features, components or portions of the asset, e.g. wherein each division comprises adjacent features, components or portions of the circuit or asset that have the same or a similar (e.g. within a threshold range) remaining lifetime or degradation rate. In embodiments, the asset is divided up into the corrosion circuits. The division process confers advantages in the effectiveness and planning of inspections. If extreme values (e.g. corresponding to the highest corrosion rates) are selected for calculating the inspection interval, then this may result in unnecessary and/or premature inspections of parts of the circuit or asset.

Inspectors and engineers often build up knowledge over time of locations where corrosion is most significant and direct inspection effort towards those locations. However, this risks becoming variable dependant on the judgement of the individuals involved, prone to human error and/or may be more easily lost over time due to staff changes. In examples, the present method uses sampling rules to form the divisions. The sampling rules use the estimated values of the of the largest degradation (e.g. corrosion) rates in order to form the divisions. The features, components or portions of the circuit or asset are divided into those giving rise to the “extreme” data, which are designated as “hotspots” and those giving rise to the “good” data, which are classified as having “general corrosion”. The identification of hotspots and “general corrosion” features, components or portions of the circuit or asset are indicated in the visualization, along with an indication of the corresponding degradation rate and/or the remaining lifetime. For example, these may be indicated with colour shading corresponding to the degradation rate and/or the remaining lifetime on an isometric view of the model of the circuit or asset (see FIG. 7) or on the P&ID or other circuit diagram.

The method results in an output dataset that comprises appropriately identified good data and extreme values. In this way the report output by the system can comprise filterable data tables, such as those shown in FIGS. 3 to 5, system summaries, heatmaps such as that shown in FIG. 6 and isometrics with the extreme values that require most imminent inspection highlighted as hotspots, as shown in FIG. 7.

The “good data” 175, and the degradation (e.g. corrosion) rates and remaining lifetimes determined for the “good data” 175 can be used as a baseline for comparison with future inspection data. This allows any new inspection data to be combined with the “good data” 175 (with may be filtered), assessed and validated immediately or at least very quickly. This may be beneficial where “in the field” or real time or near real time assessment or validation is required or beneficial. This also allows a degree of error prevention to occur prior to including inspection results in the data stores 15, 25.

Although the above processes provide “baseline” knowledge of the circuit or system, the way in which the datasets are updated can also provide additional benefits, particularly in the way it updates incomplete knowledge. Some form of machine learning model may be beneficial.

Optionally, it is possible to obtain further data, e.g. wall thickness readings in this particular example, according to a risk based inspection. The determined baselines are used to determine likely errors in the further data, which may be carried out “in-situ” or in real time or near real time. A determination is made if the determined degradation rate (e.g. corrosion rates) determined from the further data (i.e. the newly collected data) are within a threshold of the baseline determined from previous or historical data using the process of FIG. 1. If not, then further investigation is performed or requested. Examples of possible investigations include checking if process conditions have changed. If the change is determined to be genuine then the process continues as if the determined degradation rates had been within the threshold range of the baseline. If the change is determined not to have been genuine, then further inspections can be performed or determined, e.g. using a different inspection technique. In addition to the above, alarms or alerts may optionally be provided.

If the degradation rates determined from the further data are determined to be within a threshold of the baseline or the deviation from the baseline is determined to be the result of a genuine change in the circuit or asset or in the operation thereof, then a further statistical analysis can be performed on the data, and the results of the analysis used to update the risk based inspection.

The verified and validated “good data” 175 that is sufficient to allow the classification into general and localised corrosion in steps 185 and 190 can be subject to advanced statistical analysis and an alarm raising process. In this case the “good data” is provided to an alarm system that uses control charts to identify anomalies. For example, a range of statistical distributions can be fitted to the remaining (e.g. “good) data and further data to identify a best fit distribution and used to establish new degradation (e.g. corrosion) rates and remaining lifetime for each feature, component or portion of the circuit or asset. The revised degradation rates and remaining lifetimes can be fed back into the damage mechanism determination 180 and used to revise the identified degradation mechanism and/or inspection frequencies. The updated degradation rates and remaining lifetime can also be subjected or further re-subjected to verification and validation.

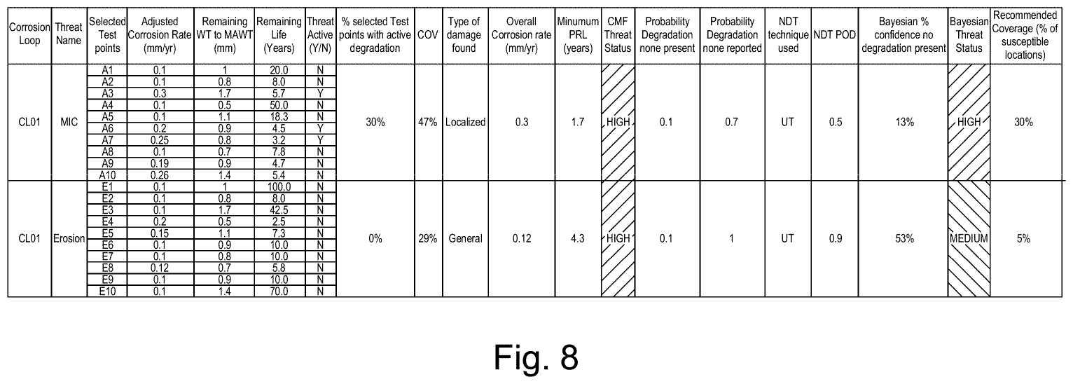

The method may output an indication of testpoint coverage, arranged to allow easy identification of testpoints that have been inspected, as shown in FIG. 8.

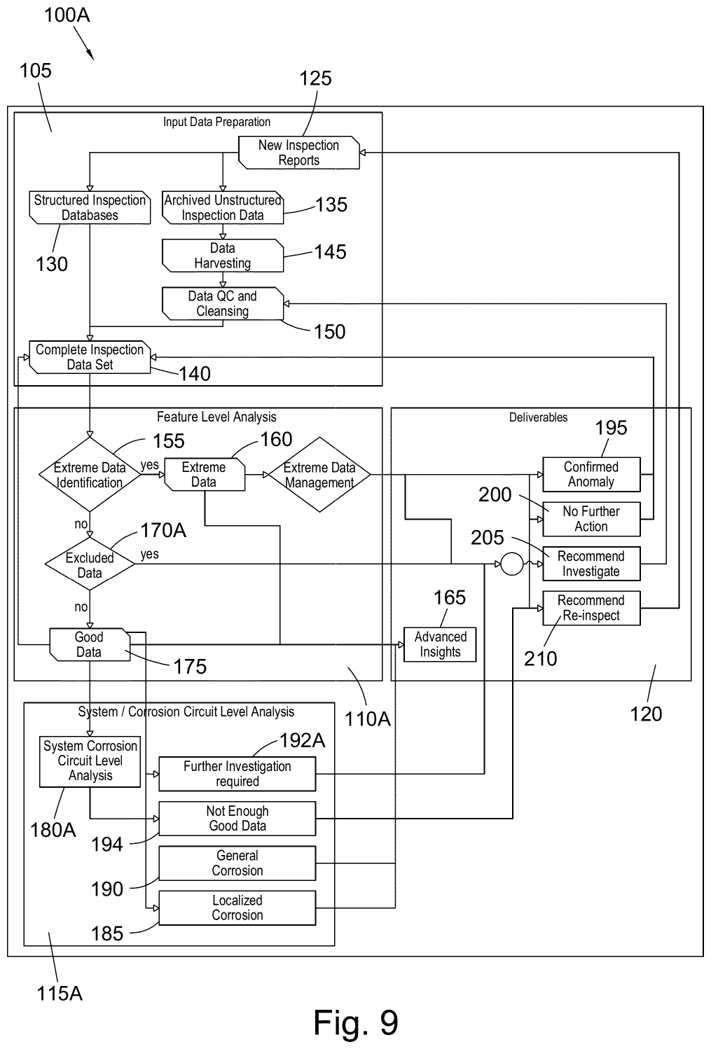

FIG. 9 shows an asset monitoring process flow 100A, that is the same as the asset monitoring process flow 100 shown in FIG. 1 in most respects, with like features being provided with the same reference numerals, but varies in some respects, with different but corresponding features being suffixed with ‘A’.

Particularly, the input data preparation stage 105 of the asset monitoring process flow 100A of FIG. 9 is the same as the input data preparation stage 105 described above in relation to FIG. 1. Similarly to the asset monitoring process flow 100 shown in FIG. 1, the data from the complete inspection data set 140 of the input data preparation stage 105 can be processed using feature level analysis 110, 110A that collects data together for respective features (e.g. measurement points, locations, components, etc.) of the asset. As in the process flow 100 of FIG. 1, the feature level analysis 110A in the process of FIG. 9 comprises processing the asset inspection data from the complete inspection data set to identify if any of the data can be classified as “extreme data” 155 that is considered as potentially anomalous and requires potential action. If data in the complete inspection data set is identified as being extreme data 160 then the extreme data is flagged as such and forwarded to the advanced insights module 165 to be provided to a user for asset condition monitoring, and can be flagged for further action, such as re-inspection 210, re-measurement or manual investigation 205.

If data in the complete inspection data set 140 is not classified as extreme data, i.e. it does not meet any of the requirements set out in the extreme data rule set that specifies the extreme data 160, then it is passed to a further check to determine if the data is potentially anomalous but benign 170A (which equates to “excluded data”). In the example of FIG. 1, this comprises determining if a wall thickness is above a nominal or expected value. However in the example of FIG. 9, this determination of whether the data is “excluded data” (i.e. anomalous but benign) can comprise alternative or additional conditions, such as a determined corrosion rate being below a threshold amount. Significantly, in the process 100A of FIG. 9, in addition to being segregated from the rest of the data (e.g. from the good data), the “excluded”/anomalous but benign data is flagged for further action, such as re-inspection 210, re-measurement or manual investigation 205, amongst other possible actions, such as being segregated as a confirmed anomaly 195.

As in the process flow 100 of FIG. 1, any data that is neither identified as extreme nor “excluded” / benign but potentially anomalous is considered to be “good data” 175 that is provided to an advanced insights module 165 and also further analysed using circuit level analysis 115A.

In particular, for each respective circuit, good data 175 from the feature level analysis is further analysed using a circuit level analysis 180A, such as a corrosion circuit level analysis. This comprises analysing, at a circuit level, if any of the “good data” 175 output from the feature level analysis requires further investigation 192A, or if there is simply not enough good data 194, if it is indicative of general corrosion 190 or if it is indicative of localised corrosion 185. The determination of there being not enough good data 194, of general corrosion 190 or of localised corrosion 185 is as described above in relation to FIG. 1.

A determination of “requires further investigation” 192A is not necessarily dependent only on there being an above threshold ratio or percentage of wall thickness measurements that are above an expected or nominal value, but could also depend on other factors. If it is determined that data “requires further investigation” 192A, then it is flagged for further action, such as re-inspection 210, re-measurement or manual investigation 205, amongst other possible actions, such as being segregated if confirmed as an anomaly 195.

As noted above, the good data” 175 is provided to an advanced insights module 165. The advanced insights module 165 is as described above in relation to FIG. 3, and elsewhere and provides visualization of key metrics, such as corrosion rates, remaining lifetime, inspection requirements or intervals, identification of hotspots of particularly high corrosion or degradation, identification of blindspots that are under inspected, and/or the like. The advanced insights module 165 can also provide alerts, alarms or flags when the metrics breach alarm or alert trigger thresholds. The use of data that has been identified as “good data”, as defined above, allows for more accurate determination of the metrics and thereby better raising of alerts, flags or alarms, better determining of inspection intervals or interventions and/or the like.

It will be appreciated that the processes of FIGS. 1 and 9 can be used interchangeably and that any of the features or steps of either process can be substituted for the equivalent feature in the other process. In addition, any of the features shown and described in relation with any of FIGS. 2 to 8 can be equally used with the process of FIG. 9.

For ease of explanation, the above examples have been described as if used in relation to an asset that comprises oil and gas related pipelines, such as in a well structure extending below the surface, or the like. However, systems and methods described herein may be equally used and applicable in respect of other flow lines, not just those associated with oil and gas production, or indeed injection wells, etc. As such, while the following examples may be described in relation to oil and gas wells, and in particular production and appraisal wells, the same systems and methods, etc., may be used beyond oil and gas applications. A skilled artificer will be able to implement those various alternative embodiments accordingly.

The terms “good data”, “remaining data” and “non-segregated data” may be interchangeable.

It will be appreciated that the methods disclosed above could be implemented on a computer based system, such as but not limited to that shown and described in relation to FIG. 1 above. For example, the method may be predominantly performed by a processing system such as processing system 10, which may include one or more processors, central processing units (CPUs), one or more cores of a multi-core processor, one or more graphics processing units (GPUs), one or more maths co-processors, one or more field programmable gate arrays (FPGAs) or integrated FPGA/processor systems, one or more application specific integrated circuits (ASICS) and/or the like.

The applicant discloses in isolation each individual feature described herein and any combination of two or more such features, to the extent that such features or combinations are capable of being carried out based on the specification as a whole in the light of the common general knowledge of a person skilled in the art, irrespective of whether such features or combinations of features solve any problems disclosed herein, and without limitation to the scope of the claims. The applicant indicates that aspects of the invention may consist of any such individual feature or combination of features. In view of the foregoing description it will be evident to a person skilled in the art that various modifications may be made within the scope of the invention.

1. A method of processing inspection data, comprising:
collecting two or more datasets, each dataset comprising data associated with an inspection process of a particular asset;
isolating, from those data sets:
(i) data that varies beyond a particular threshold based on the other data within that dataset;
(ii) data that varies beyond a particular threshold based on a comparison of data between the two or more datasets;
(iii) data that is considered erroneous; and
using remaining data as inspection data for that particular inspection process.

2. A method according to claim 1, wherein accordingly to (i) or (ii) the threshold is set based on a variation that indicates erroneous data.

3. A method according to claim 1, wherein accordingly to (i) data identified as to be isolated varies outwith an expected trend

4. The method according to claim 3, wherein the trend is a linear trend.

5. The method of claim 1 wherein the using comprises:
determining minimum, average and maximum degradation rates and/or remaining lifetimes from the data isolated in steps (i) and/or (ii) and/or from the remaining data.

6. The method of claim 5, wherein using comprises:
providing a data visualisation in which the determined minimum, average and maximum degradation rates and/or remaining lifetimes are indicated, optionally in a heat map, circuit diagram or model or isometric diagram; and/or actioning investigation based on the determined minimum, average and maximum degradation rates and/or remaining lifetimes.

7. The method of claim 1 comprising:
categorising the data into two or more categories, wherein the categories comprise at least one of:
data to segregate, wherein the data to isolate comprises data that does not trend with the rest of the remaining data but is not significant;
data to investigate, wherein the data to investigate comprises data that is determined to be unlikely or unrealistic;
general data, wherein the general data comprises data that is within a threshold amount of the expected trend and has a variation within or between datasets that is less than a threshold; and
localized data, wherein the localized data comprises data that is associated with a specific portion of an asset or circuit and has intra- or inter- data set variation in data from the datasets for a portion of an asset or circuit that is above a variation threshold.

8. The method according to claim 1, comprising determining one or more hotspots, the hotspots being components or portions of a circuit or asset that give rise to data meeting criteria (i) and/or (ii), and providing at least one of: an indication of the hotspots, a request to re-inspect the hotspots and/or an alarm or alert indicating the hotspots.

9. The method according to claim 7, comprising determining or fitting a probability distribution to the localized data, and using the determined or fitted probability distribution for the localized data to determine a remaining lifetime or maximum corrosion rate for at least one component or portion of a circuit or asset.

10. The method according to claim 5, comprising dividing a circuit or asset into divisions, each division comprising one or more components or portions of the circuit or asset, wherein each component or asset in the division has a degradation rate, average degradation rate or maximum degradation rate, or remaining lifetime that is the same or within a threshold of each of the other components or portions of the circuit or asset in the respective division.

11. The method according to claim 10 comprising determining an inspection time or frequency for each division based on the degradation rate, average degradation rate or maximum degradation rate, or remaining lifetime of the components or portions of the circuit or asset in the respective division.

12. The method of claim 1 wherein the datasets comprise manually input datasets and/or datasets collected by sensors or measurement tools configured to measure one or more properties or parameters of at least part of the asset or circuit.

13. A processing system, the processing system comprising:
one or more processing modules
one or more data stores;
a communications system;
one or more user input devices, for receiving user input; and
one or more display or other output device; wherein
the processing system is configured such that the one or more processing modules are configured to receive or retrieve two or more datasets from the one or more data stores, via the communications system and/or from the one or more user input devices, each dataset comprising data associated with an inspection process of a particular asset;
the processing system being configured to:
isolate, from those data sets:
data that varies beyond a particular threshold based on the other data within that dataset:
(ii) data that varies beyond a particular threshold based on a comparison of data between the two or more datasets;
(iii) data that is considered erroneous; and
the processing system is configured to provide a visualization, indication and/or alert based on remaining data that remains after the isolation and/or the data identified in (i) and/or (ii).

14. A computer program product embodied on a non-transient carrier medium, and configured such that when implemented on a processing system causes the processing system to:
collect two or more datasets, each dataset comprising data associated with an inspection process of a particular asset isolate, from those data sets:
(i) data that varies beyond a particular threshold based on the other data within that dataset;
(ii) data that varies beyond a particular threshold based on a comparison of data between the two or more datasets;
(iii) data that is considered erroneous; and
use remaining data as inspection data for that particular inspection process.

15. A graphical user interface (GUI) implemented on a computer based system, the GUI being configured to display one or more of:
one or more hotspots;
the average, maximum and/or minimum degradation rates; and/or
remaining lifetime for an asset or circuit or one or more features, components and/or portions thereof; wherein the average, maximum and/or minimum degradation rates are determined using the method of claim 5.
